(19) United States
(12) Patent Application Publication
(10) Pub. No.: US 2002/0089470 A1
(43) Pub. Date: Jul. 11, 2002

(54) Real time internet transcript presentation system

(76) Inventors: Mithila Raman, Pleasanton, CA (US); Andrew Feig, Merrick, NY (US); Sam Edge, Danville, CA (US)

Correspondence Address: Christian C. Michel, Roylance, Abrams, Berdo & Goodman, L.L.P., Suite 600, 1300 19th Street, N.W., Washington, DC, 20036, US

(21) Appl. No.: 09/988,803

(22) Filed: Nov. 20, 2001

Related U.S. Application Data
(60) Provisional application No. 60/252,562, filed on Nov. 22, 2000.

(51) Int. Cl. G09G 3/00

(52) U.S. Cl. 345/30

(57) ABSTRACT

A system and method are provided for producing a real-time transcript of a live presentation. A stenographer produces a stream of phonemes which are translated into human language text and further formatted for presentation on a display device, such as in a web browser. A computer readable file is stored on a server an contains the human language text which has been formatted for presentation on a display device. The computer readable file is periodically concatenated to include the most recent text. The computer readable file is periodically transmitted over a network to client computers to be displayed in a client application, such as a web browser, and can be transmitted at set intervals, or at the request of the client.

that allows any language that can be represented phonetically to be written in real-time on a stenotype machine by a trained and licensed stenographer. This capability has existed since 1987. The phonetic language is translated into English language text in real-time along with the appropriate punctuation and paragraph formatting.

When the spoken word is captured by phonetic strokes on a stenographic device, the phonemes are captured and interpreted by Computer Assisted Translation (CAT) software running on a computer. The CAT software has the ability to translate the phonemes into English text in real-time and output this text via a communications port, such as, for instance, an RS-232 serial port.

Digital technology and the Internet allow a wide variety of media types to be transmitted quickly to any computer connected to the Internet. Examples of the types of media which can be transmitted are audio and video files, image files, text files, and the like. Streaming media have become a popular means of transmitting live presentations to a wide audience over the Internet. Streaming presentations often include video and audio information. Unfortunately, not all computers connected to the Internet are capable of receiving streaming audio and video. Furthermore, it is not always desirable to receive a streaming presentation in video or audio format even if the computer is capable of doing so.

Therefore, it would be beneficial to provide access to a real-time text transcript of a presentation. The text transcript would have the advantages of being accessible to a wider range of computers, and also would provide an alternative format for users desiring to avoid a streaming audio and/or video presentation. Furthermore, real-time text transcripts could be used in conjunction with streaming audio/video presentations to enhance the presentations, and provide a more complete record of a presentation.

### SUMMARY OF THE INVENTION

The present invention relates to the output and subsequent data processing of text that is generated by the processes of the phonetic writing device and/or the CAT devices and/or programs.

The present invention relates to a system for providing a transcript of a live presentation comprising a transcription device adapted to produce human readable text in real time from a spoken presentation, a formatter adapted to produce formatted text from the human readable text for display on a display device, and a server connected to a network for storing the formatted text in a file.

The present invention is further related to a method of providing a transcript of a presentation comprising the steps of converting a spoken presentation into human readable text, formatting the human readable text for display on a display device, and storing the formatted text in a file on a server connected to a network.

The present invention is further related to a computer readable medium of instructions for controlling a system to provide a transcript of a presentation. The medium of instructions includes a first set of instructions adapted to control the system to convert phonemes from a stenography machine into human readable text, a second set of instructions adapted to control the system to format said human readable text for display on a display device, and a third set of instructions adapted to control the system to store said formatted text in a file on a server connected to a network.

### BRIEF DESCRIPTION OF THE DRAWINGS

The various objects, advantages and novel features of the present invention will be more readily understood from the following detailed description when read in conjunction with the appended drawings, in which:

FIG. l is a block diagram of a system according to an embodiment of the present invention;

FIG. 2 is a block diagram of the transcript production system in accordance with an embodiment of the present invention as shown in FIG. 1;

FIG. 3 is a block diagram of the client transcript system in accordance with an embodiment of the present invention as shown in FIG. 1;

FIG. 4 is an example of a computer display screen shot generated by the embodiment of the present invention shown in FIG. 1;

FIG. 5 is an example of a computer display screen shot generated by the embodiment of the present invention shown in FIG. 1; and

FIG. 6 is an example of a computer display screen shot generated by the embodiment of the present invention shown in FIG. 1.

Throughout the drawings, like reference numerals will be understood to refer to like parts and components.

### DETAILED DESCRIPTION OF THE INVENTION

A Real-Time Internet Transcript Presentation System in accordance with an embodiment of the present invention is illustrated in FIG. 1. The overall system 100 May be broken down into two main parts. The first part is the Transcript Production System 102, and the second part is the Client Transcript System 104. The Transcript Production System 102 converts a series of phonemes generated by the stenographer and converts them into HTML coded English text and transports them to a central server storage location. The Transcript Production System 102 will be described in further detail below. The Client Transcript System 104 presents the HTML coded English text within a client side application on a device such as a personal computer which is connected to a network such as the Internet.

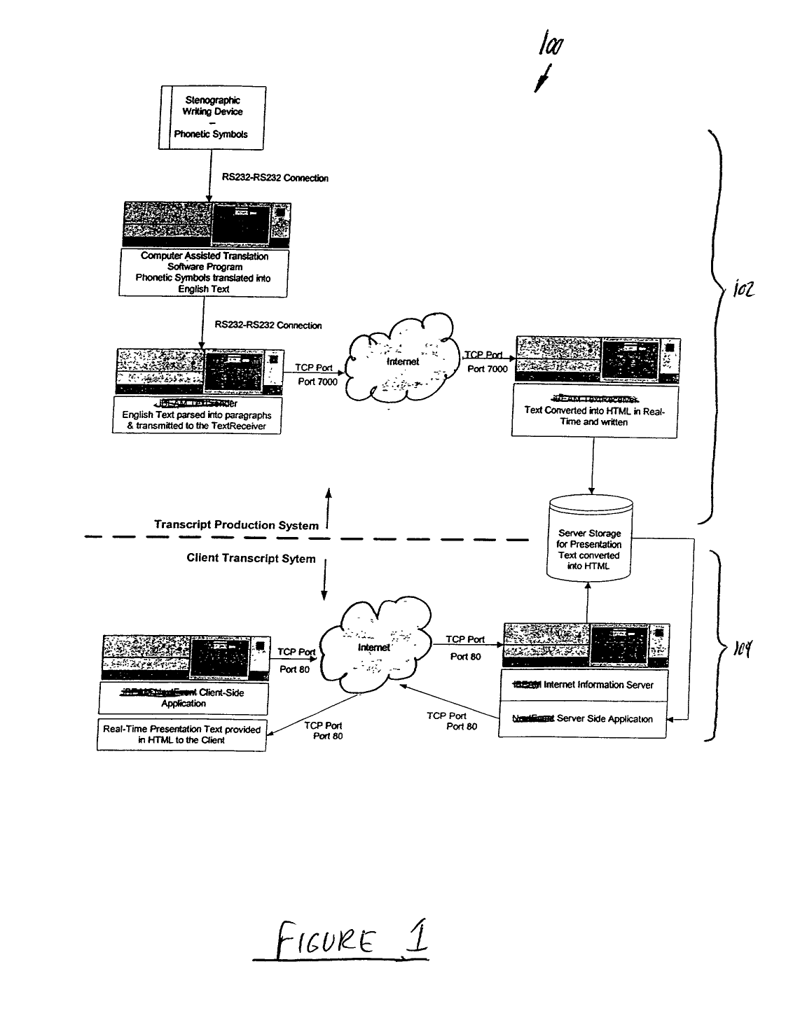

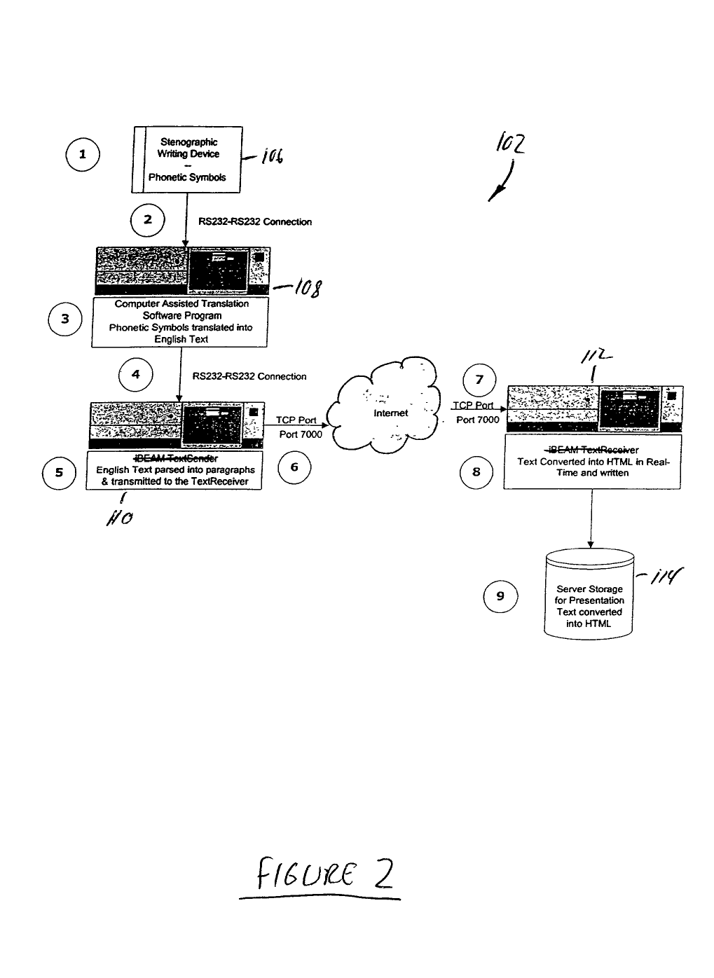

The Transcript Production System 102 will be further understood with reference to the following description in conjunction with FIG. 2. The Transcript Production System 102 comprises a stenographic writing device 106, such as for instance the Stentura 4000. The Stenographic writing device 106 is used by an stenographer to manually capture the spoken word of the presentation by typing phoems by pressing one or more steno keys simultaneously. A brief example of stenographic keystrokes in their respective translations into English is depicted in the following Table:

| | Steno written by | |
|---|---|---|
| Stroke | Stenographer | Translated English |
| 1 | WEL | Stroke 1 & 2 combined for welcome |
| 2 | KOPZ | Welcome |
| 3 | TO | To |
| 4 | OUR | Our |
| 5 | SAOEUT | Site |

The Transcript Production System 102 further comprises computer-rated translation (CAT) software running on a computer 108. The computer 108 preferably has a communications port such RS-232 port and is connected to the stenographic writing device 106 through the RS-232 port. Of course, those of skill in the art will recognize that the invention is not limited to RS-232 port but rather that port is provided merely as an exemplary form of communication between the two devices. The computer 108 running the computer-assisted translation program converts phonetic symbols received from the stenographic writing device 106 into English text. Shown in the Table above are five exemplary steno strokes. The first two strokes form a concatenated steno string of WELKOPZ which is in turn translated into the work “welcome.” The “WELKOPZ” is the phonetic representation of the word “welcome.” The third stroke of “TO” translates to English “to.” Forth stroke of “OUR” translates to English “our”, and the fifth stroke of “SAOEUT” phonetically represents the word “site.” The translated English text from the TAT software is transmitted view computer 108 second communications port to a host computer 110 running a text transmission program. Of course, those of skill in the art will recognize the computer 108 and computer 110 could be the same computer running both the CAT software as well as the text transmission program. The text transmission program within computer 110 stores text received from the CAT program running on computer 108 until an incoming paragraph marker is recognized. Once a paragraph marker is recognized, the entire stored paragraph of text is prepared for transmission over a network connection to a text-receiving program located on computer 112.

In a preferred embodiment of the invention, the text sending program on computer 110 sends paragraphs of English text via a TCP/IP protocol on TCP port 7000 across the Internet where is received on the computer 112 TCP port 7000. Thus, it would be understood that computer 110 and computer 112 can be any two computers with an Internet connection. The TCP is a standard protocol used to communicate across the Internet to a specific IP (Internet protocol) address a typically unique to each computer attached to the Internet. Port 7000 is typically an unused TCP port, but of course those of skill in the art will recognize it that any suitable TCP port could be used. Furthermore, any suitable means of communication between two computers is contemplated to be within the scope of the invention. The TCP/IP protocols are shown for illustrative purposes, as well as their widespread usage. Computer 112 running text receiving program listens on exemplary port 7000 for incoming TCP packets. The incoming TCP packets contain packaged text from the text-sending program on the computer 110. As the text-receiving program running on computer 112 received packets of text, the text receiver program processes the text into an HTML document. This HTML is then appended or concatenated, to any prior HTML document to form a new HTML file. The new file is then placed on a storage server 114 where it can be accessed by a client.

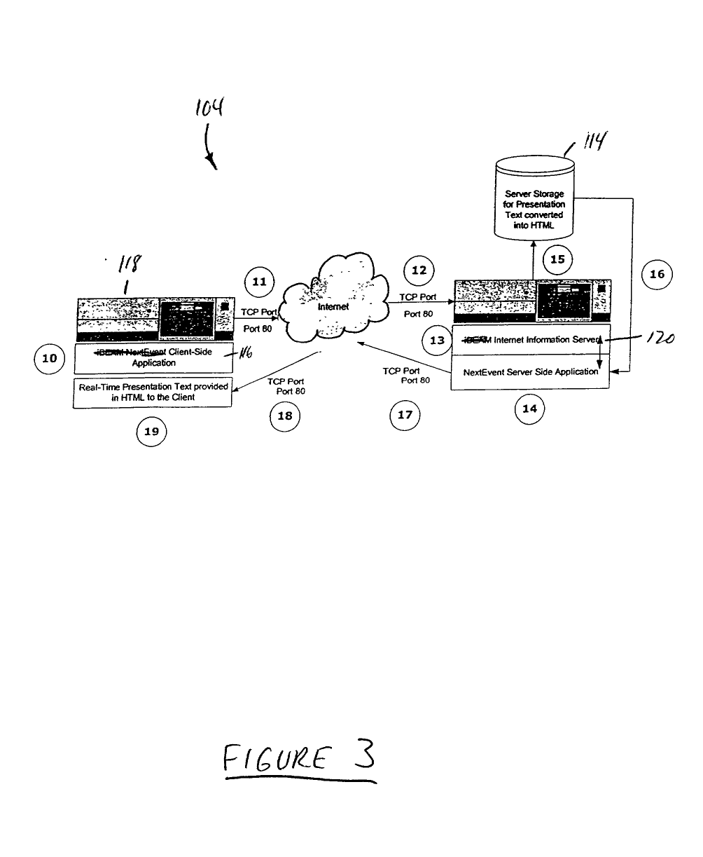

The client transcript system 104 will be better understood with reference to the following text in conjunction with FIG. 3. The client transcript system comprises a client side application 116 residing on a client computer 118. The client side application 116 is a series of ASP (Active Server Pages) that are retrieve from an Internet Information Server 120. The client is able to retrieve these pages by going to default URL (Universal Resource Locator), such as www.presentation.ibeam.com. The Active Server Pages can be viewed from within a standard web browser, as is understood in the art. It should be understood that ASP is described herein as one type of technology which allows for processing on a Microsoft web server using Internet Information Server software. ASP is not meant to be limiting, but rather it should be understood that any technology which provides for dynamic viewing of content within a web browser is considered to be within the scope of the invention. Within the default URL will be a link to a set of pages that will allow the client to authenticate himself or herself, if required, and to select the particular presentation URL for the on-line presentation they whish to view. The client is able to select the URL for their particular presentation within their browser and this request is sent from their computer 118 via TCP port 80 which as is known in the art is the standard TCP port address for HTTP communications.

This request is delivered to the Internet Information Server 120 which is responsible for receiving and fulfilling URL requests. The Internet Information Server receives a requests via its corresponding TCP port 80. The Internet Information Server (IIS) 120 response to a request by running specific scripts located in the ASP document corresponding to the selected URL. The requested URL in turn points to a specific ASP page which continues scripts, and code segments, to retrieve and return the presentation text that has been formatted into HTML documents. Thus, the Internet Information Server 120 retrieves the HTML document associated with the relevant presentation from the server 114 and transmits the HTML documents back to the client computer 118 via TCP port 80. Upon a request, the ASP page causes the Internet Information Server to retrieve the most recent version of the HTML document stored on server 114. The text in the HTML document is then packaged and sent back to the client via the TCP port 80. The HTML text is then received at TCP port 80 on the client computer 118 and is displayed within the Internet browser running on the client's computer 118.

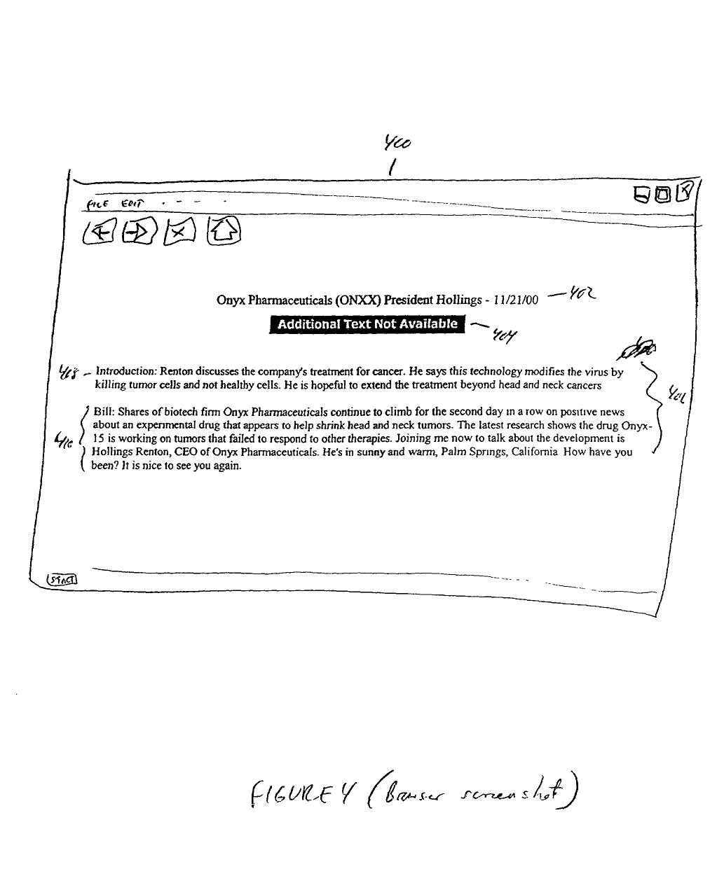

It should be understood that the presentation transcript is being delivered “live.” However, the text is being transmitted to the host upon connection and there is no guarantee that the client will connect before the presentation begins, that each client will connect at the same time, or that each client reads at the same rate of speed. A system according to an embodiment of the present invention is capable of dealing with all three of those conditions. Regardless of when the client connects to the presentation URL, the most current text on the initial connection will be presented to the client within his browser. The following examples of how presentation transcript is transmitted to the client will be better understood with reference to FIGS. 4, 5 and 6.

FIG. 4 illustrates a screen shot of a transcript presentation in accordance with an embodiment of the present invention. The screen shot represents what a user of a client PC would view within a standard browser window 400 once connected to a live presentation transcript. A presentation title 402 is presented. A presentation status button is presented at 404, and the presentation text presently available is displayed at 406. For the convenience of the user, and introductory text may be inserted before any transcription, as shown at 408. In this view, and initial portion of transcribed text is displayed, as shown at 410. As shown in FIG. 4, the status button 404 displays the message “Additional Text Not Available”. In this manner the user is made aware that their browser is displaying all of the text presently available for the presentation.

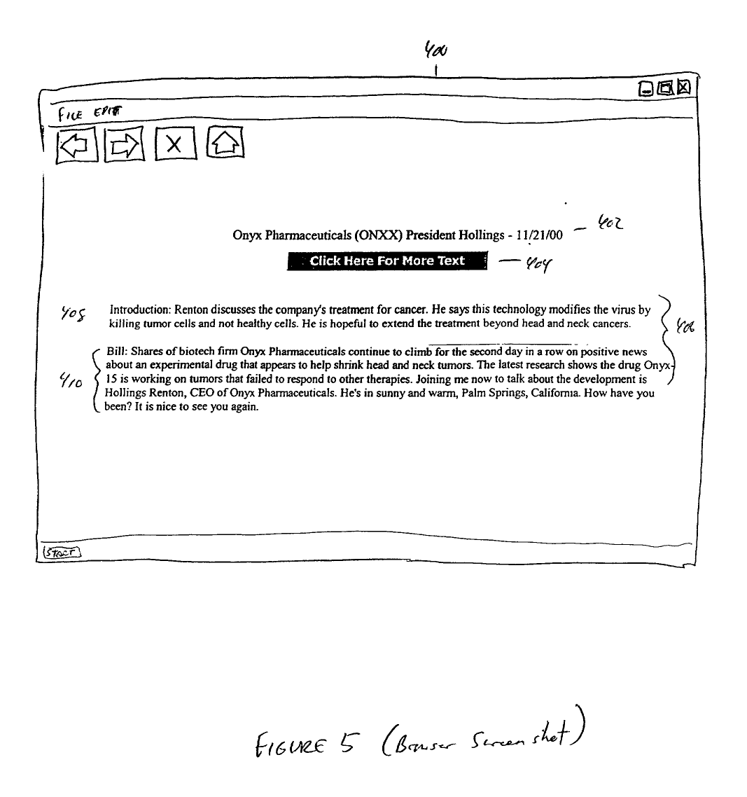

FIG. 5 illustrates a screen shot as in FIG. 4, after a period of time has elapsed, and more text has been made available for the presentation. In this view, status button 404 displays the message “Click Here for More Text.” The user has the option of clicking on this button to cause the browser to retrieve and display additional text transcribed from the live presentation since the last time the browser was updated.

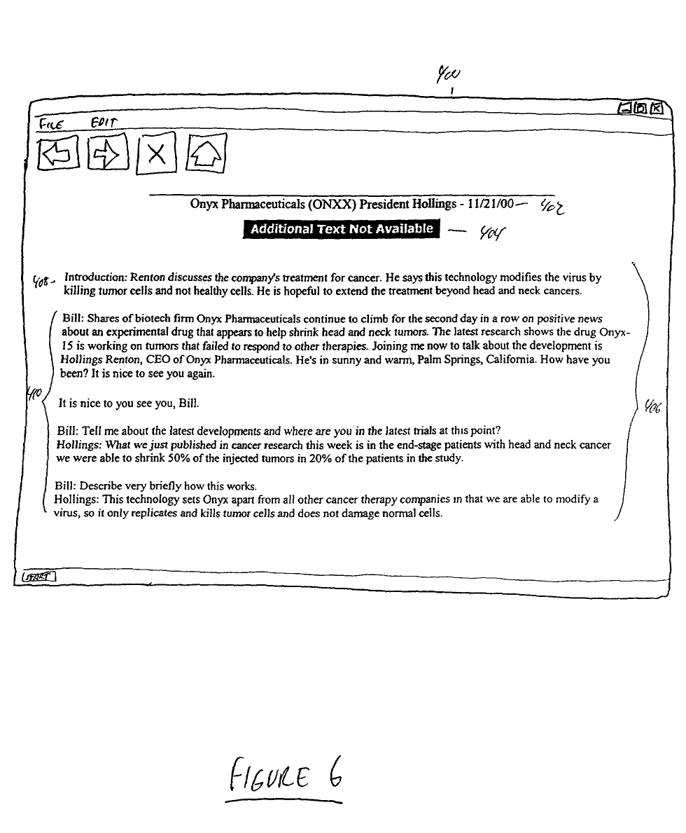

FIG. 6 illustrates a screen shot as in FIG. 5, showing an example of what the user would see after clicking on the status button 404 displaying the message “Click Here for More Text.” The browser 400 has connected to the server 114, and retrieved the most recent formatted text which has been generated from the live presentation. The additional text is added to the previously displayed text, and is shown in FIG. 6 at 410.

In the manner illustrated in FIGS. 4-6, a system according to the present invention is capable of delivering a text transcript of a live presentation, in real-time, over the Internet to users at computers connected to the Internet.

As will be understood, the forgoing example is described for illustrative purposes only, and the invention could take on a wide variety of implementations, and remain within the scope of the invention. The forgoing description is not intended to be limiting in any way, but rather the scope of the invention is set forth in the following claims.

What is claimed is:

1. A system for providing a transcript of a live presentation comprising:
a transcription device adapted to produce human readable text in real time from a spoken presentation,
a formatter adapted to produce formatted text from said human readable text for display on a display device, and
a server connected to a network for storing said formatted text in a file.

2. The system of claim 1, further comprising:
a client computer connected to said network, said client computer being adapted to access said server and retrieve said file.

3. The system of claim 1, wherein said transcription device comprises a stenography machine.

4. The system of claim 3, further comprising a phoneme translator, wherein said stenography machine produces phonemes which are translated into human readable text by said phoneme translator.

5. The system of claim 1, wherein said formatted text comprises Hypertext Markup Language.

6. The system of claim 1, wherein said display device comprises a computer running web browser software.

7. The system of claim 1, wherein said server is further adapted to periodically update said file with new formatted text from said formatter.

8. A method of providing a transcript of a presentation comprising the steps of:
converting a spoken presentation into human readable text,
formatting said human readable text for display on a display device, and
storing said formatted text in a file on a server connected to a network.

9. The method of claim 8, further comprising the steps of accessing said file from a client computer connected to said network, a displaying said file.

10. The method of claim 8, wherein said converting step comprises performing stenography.

11. The method of claim 10, further comprising the steps of producing phonemes from said spoken presentation, and translating said phonemes into human readable text.

12. The method of claim 8, wherein the formatting step further comprises formatting said human readable text into Hypertext Markup Language.

13. The method of claim 8, further comprising the step of displaying said formatted text within a web browser running on a client computer.

14. The method of claim 8, further comprising the step of updating said file with new formatted text converted from a subsequent portion of said spoken presentation.

15. A computer readable medium of instructions for controlling a system to provide a transcript of a presentation comprising:
a first set of instructions adapted to control said system to convert phonemes from a stenography machine into human readable text,
a second set of instructions adapted to control said system to format said human readable text for display on a display device, and
a third set of instructions adapted to control said system to store said formatted text in a file on a server connected to a network.

16. The computer readable medium of instructions as in claim 15, further comprising a fourth set of instructions adapted to control said system to transmit said file to a client computer connected to said network.

17. The computer readable medium of instructions as in claim 15, wherein said second set of instructions if further adapted to format said text into Hypertext Markup Language.

18. The computer readable medium of instructions as in claim 15, further comprising a fifth set of instructions adapted to control said system to display said formatted text within a web browser running on a client computer.

19. The computer readable medium of instructions as in claim 15, further comprising a sixth set of instructions adapted to control said system to update said file periodically with additional formatted text converted from a subsequent portion of said spoken presentation.
